(19) United States
(12) Patent Application Publication
(10) Pub. No.: US 2008/0241796 A1
(43) Pub. Date: Oct. 2, 2008

(54) Apparatus for Digitalization of Dental Structures, and Method for Recognition of Three-Dimensional Data of Dental Structures

(76) Inventors: Gabriela Ce, Porto Alegre (BR); Renato Oliveira Rosa, Porto Alegre (BR); Manuel Menezes de Oliveira Neto, Porto Alegre (BR)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/093,692

(22) PCT Filed: Dec. 8, 2006
(86) PCT No.: PCT/BR2006/000268

§ 371 Date: May 14, 2008

(30) Foreign Application Priority Data
Dec. 9, 2005 (BR) PI0505860-0

(51) Int. Cl. A61C 7/00; A61C 3/00

(52) U.S. Cl. 433/215; 433/72

(57) ABSTRACT

An apparatus for digitalization of dental structures which is precise and efficient, generating unequivocal three-dimensional data. The apparatus of the invention comprises at least one articulated arm and at least one probe, said articulated arm and probe providing dental structure scanning directly by mouth contact, being a comfortable device for the patient. The method of the invention provides an advantageous way by which dental structure moulds can be produced, since it generates very accurate three-dimensional data of the dental.

### FIELD OF THE INVENTION

The present invention describes an apparatus for scanning and providing spatial information of dental structures. It is also related to a method of preparing dental prostheses using the referred apparatus.

### BACKGROUND OF THE INVENTION

Three-dimensional digitalization is the process through by which one can “feel” a three-dimensional object so as to create its three-dimensional representation that can be digitally manipulated by a computer system which provides a representation of the object. There are various available devices which are able to digitalize three-dimensional objects. A common type of digitizer uses a probe-like apparatus, with a pointer, to trace under the surface of a three-dimensional object and in this way provide data from spatial coordinates to a system. The system is able to receive information from the probe through points in different coordinates. The points may be joined and presented with a net representation. A three-dimensional model may be created by the system from a net representation of an object. Another common probe-like device uses mechanical connections and sensors to determine the pointer's position or another probe that is tracing the three-dimensional object. The pointer is fixed to the end of a series of mechanical connections, and the other end of the connections is connected to a fixed base on a non-movable surface. Sensors may be included in the articulations of the connections to determine the relative orientation of connections, the pointers being fixed in relation to the base. The angle read by the sensors can be converted into coordinates through an interface with a microprocessor or by the computational system.

In the state of the art, problems with digitalization methods and devices occur mainly because the user becomes compelled while he traces the object which must be digitalized. Normally, the user must trace the object in particular surfaces and in particular directions: This may cause errors in the resulting net representation when the surface is traced in the wrong direction or when the points are not adequately connected. In addition, a user many times does not visualize the net representation until a large portion of the object has been traced by the digitalizing device. This allows errors to be introduced into the net representation and cause loss of time in correcting the net representation, since the user cannot immediately determine if any point has been erroneously inserted. Other source of imprecision occurs when the methods and devices for digitalization of 3D objects of state of the art are used. For example, a user may wish to move or rotate an object which has been only partially digitalized to gain access to surfaces which are of difficult access. The object may be placed, for example, on a rotating table, to help to rotate the object. Nevertheless, once the object is moved, the computational system cannot develop a net representation of the object's original position.

In state of the art for digitizers, the user must first select 3 or more points of the object, move the object to the desired position, and re-select the 3 or more points in the new position. The host computer is able to transform the coordinates, considering the object's new position, and so may develop the network representation. Nevertheless, this procedure normally introduces errors in the network representation, since it is difficult to accurately re-select the same points in the object's new position. In addition, this is a time and patience consuming process, which requires constant interruptions in the digitizing process.

In many known devices, the user is impaired by the building joints of the connections. Since the cables pass through the joints to carry the sensors' electric signals, the joints normally include apparatuses which limit its movements in less than 360° to prevent the cables from getting twisted. This limited movement is inconvenient to the user in the process of tracing the object, especially when a joint's limit is reached in a certain direction and an extra movement is required to trace the object's surface.

There are yet more problems in the known devices. Since digitizing devices must “feel” an object to provide valid coordinates to a computational system, sensor calibration is of crucial importance to compensate for variations in the mechanical structure of joints and connections. In the state of the art devices, calibration is normally done by setting the point or other probe in known places in space and recording the scans of these positions. Deviations between scans of known positions and the measured scans may be used as parameters for calibration. Nevertheless, these calibration methods require that known localities be defined and the pointer be accurately fixed to these localities. This may produce expensive and precise installations. In addition, this method is slow and cautious, and may be tedious.

Besides these, other procedures in the state of the art may be disadvantageous and/or time consuming. Digitizing devices commonly use relatively cheaper sensors which detect device connection position change instead of reading an absolute angle for the connection's position. When such sensors are used, a calibration process is normally undertaken each time the device is turned on to provide initial reference angles. For example, in the state of the art, this calibration may be done by moving each joint individually until the limit of its movement and the initial angles are regulated/calibrated on these points. Nevertheless, in devices with 4, 5 or 6 degrees of freedom, this procedure may become very slow, and must be done each time the apparatus is turned on. Other devices use a defined initial position to provide the starting angles. The pointer is placed inside a receptacle at the base of the apparatus in a way that the initial reference angles for all sensors are known when the device is turned on. Nevertheless, to have a receptacle with a known initial position, a bigger base is necessary so as to cover a bigger surface area on a support surface, such as a tabletop, which can be inconvenient. In addition, the more degrees of freedom a digitizing device has, the more joints must be calibrated/regulated between the base and the probe. The larger the number of zones which need to be calibrated, the bigger the chance of introducing errors in the calibration process.

One of the application areas for these digitizing devices is dentistry. More specifically, for digitizing dental structures aiming the construction of more precise and efficient prosthetic units. In Brazil, devices for this purpose already exist. Technology such as the Procera system (Nobel Biocare) and Cerec In-Lab (Sirona) already permit digital reading of models to make 3D components. The Procera system does the optic reading from a pre-existing plaster model. In this way, as suggested in the development of the present invention, the clinical molding step would be eliminated (which includes: a mould, individual or not, molding material and a plaster mould), thus increasing the possibility of errors. The Cerec system performs the digital reading by capturing images, and the details of the copied surface must be outlined afterwards by a professional using a software, which may lead to important adaptation and/or user faults. The system of crowns, bridges and prostheses on PROCERA implants (NOBEL BIOCARE), uses the technology known as Computer Assisted Design (CAD) to produce prosthetic infrastructures in industrial scale composed of 99.5% aluminum oxide densely sintered (PROCERA ALLCERAM) or zirconium (PROCERA ALLZIRKON). These structures are thereafter covered with a special ceramic jacket for the system. The computer design is obtained through reading the whole plaster mould surface, by a ruby tip in a scanner connected to a computer. This scanner reads the mould's whole periphery from the cervical edge until the occlusal-incisal portion. This scanning may take 2 to 3 minutes and register about 50,000 points of the scanned mould. Registered in a proper software, these points offer a three-dimensional image which can be analyzed and manipulated by the laboratory technician and make way for virtually designing the ceramic structure. The virtual elaboration starts by choosing and marking a point at the image's cervical limit. Once this point is determined, the computer is able to trace a line that corresponds to the cervical end of the dental preparation. By magnifying and rotating the virtual image, the technician may then visualize and rectify point to point the entire cervical limit, securing the future coping a marginal adaptation close to perfection. After this step, the coping's type and thickness must be selected on the computer. The coping's material and thickness must be previously determined by the dental surgeon, based on esthetical and mechanical requests of each clinical case. The virtual image of the mould and coping is then sent via modem (together with patient data and data from the laboratory that sent it) to one of three production sites (for example, USA or Sweden), where after it is received, the ceramic structure will be immediately produced, in less than five hours. This structure will pass through quality control and will be sent to the country of origin, where it will be proofed by the dentist and receive variegated ceramic covering from the laboratory technician.

Following this trend, there is a version in the dentistry area that mixes electric and mechanic components, called CEREC (SIRONA). CEREC permits computer-dentist interaction, based on a CAD/CAM production system of ceramic restorations in a single session, eliminating the need to send moulds to prosthetic laboratories. Dental software is based on characteristic lines which define the cavity and permit the computer to automatically calculate how the restoration will be made parting from the lines and from information captured by the prepared tooth's image. The method consists of: tooth's cavity preparation by the dentist; capturing the image from the intra-oral camera (based on infrared rays) from the unit which is heated at 37° Celsius, uses computerized tomography technology and measures, in 3D, the dental cavity's dimension; programming the unit for producing the block (which consists of reconstitution by phases determined by the CEREC 2 program) and, afterwards, in milling the ceramic piece (BUIATI, 1999). However, computational systems suggest that for better adaptation of the piece ideal prosthetic preparations where a regular or smooth preparation box surface is needed and a non influence of the cusps inclination in the piece's adaptation (K. SATO, H. MATSUMURA e M. ATSUTA, 2002).

Patent literature also comprise examples of dental structure digitalization devices/methods. North American patent application US 20040252188, filed by Jason Elder, describes a dental imaging system comprising a sensor and a base. However, the sensor detects certain points manually, largely increasing the model's degree of imprecision generated by these points.

North American patent application US 20040188625, filed by Sirona Dental Systems, describes an image detector to generate digital images. The detector is adapted to receive X-ray images and transform them in digital images. However, as experts in this technique may confirm, to generate an image of an entire dental arch, many X-rays would be necessary, burdening the process. In addition, there is the imprecision of X-ray plates, which are detected only after the X-rays are made.

The international patent application WO 04073542, filed by Albadent Limited, describes a system for storing and retrieving information related to dental images. It concerns a system comprising various “client” computers which are capable of reproducing dental images from a mainframe. However, the present document refers to a system that deals with files generated from digitization of dental structures, not to the process in itself.

The European patent application EP 1392158, filed by Centre National de la Recherche Scientifique, describes a method for acquisition and treatment of dental images, comprising means of exciting the tooth's upper surface (crown) using monochromatic ultraviolet light pulses alternating with visible light and means of generating images through fluorescence emitted by the tooth to improve the diagnosis of cavities in the examined area. However, the referred document is related to image acquisition only of a tooth's upper surface (crown).

As the known systems present high costs with equipment, which may vary from 60 to 150 thousand dollars, since the scanning process does not eliminate the need to make the patient's mould, their practical use is limited and/or impaired. Therefore, one objective of the present invention is to provide the reading of the structure of the prosthetic preparation directly in the patient's mouth. With this approach, errors and adaptation faults are minimized, moulding appointment time is reduced, so as the patient's and dentist's weariness, resulting in 3D structures with lower cost than the currently used systems. The present invention—a digitizer for dental structures which scans directly by mouth contact—also enables dental surgeons to make copies of patient's teeth information by passing the digitizer with an articulated arm at selected points and sending information to software, transforming them in data for 3D. The data thus supplied can be transformed in pieces for later confection of the ceramic crown. This fact will allow the dental surgeon to use an original technology and which will certainly reach international projection of utilization and commercialization.

Based on the information of the art described above, the inventors developed a device and a process for dental structure digitalization, which aim to minimize faults found in the state of the art through the use of scanning directly by mouth contact. These and other objectives of the invention will be described in further detail hereinbelow.

### BRIEF DESCRIPTION OF FIGURES

FIG. 1 shows the design of the original probe of a three-dimensional structure digitizer.

FIG. 2 shows the probe kit, where 3 different angle configurations can be verified, which permit and facilitate scanner access to the 4 hemi-arches of the mouth cavity.

FIG. 3 shows the digitizer and the probes which may be substituted according to needs of mouth scanning.

FIG. 4 shows a schematic design of the clinical situation during the process.

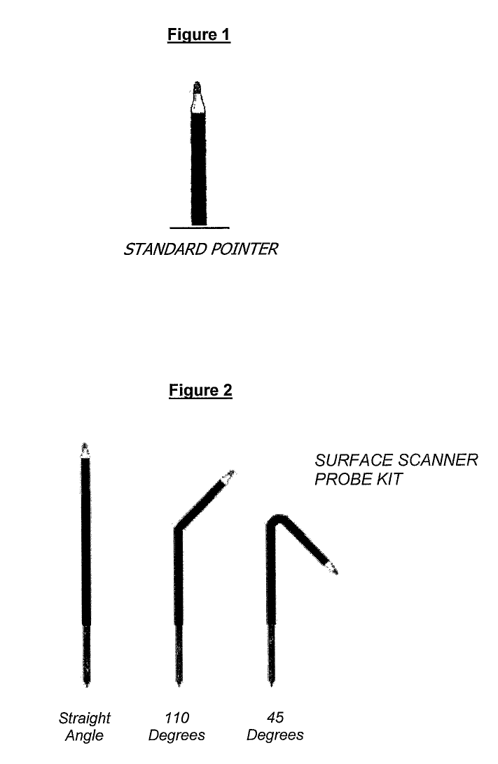

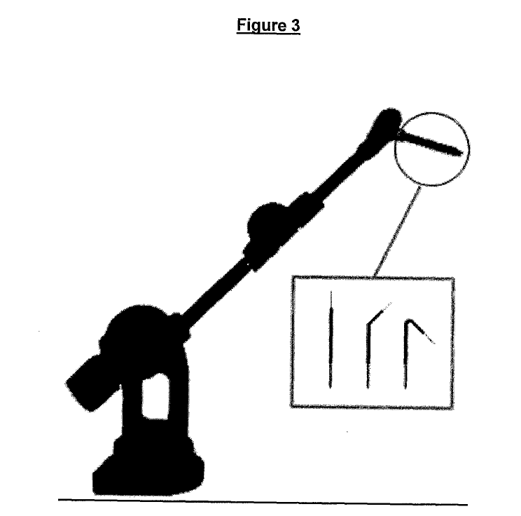

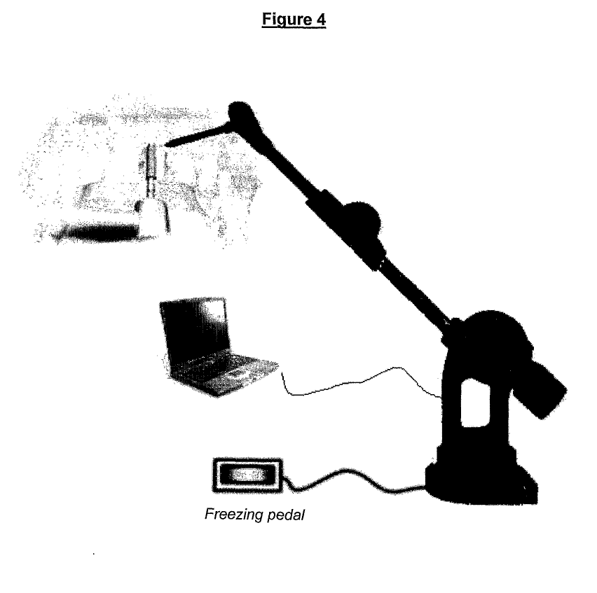

### SUMMARY OF THE INVENTION

Digitization of dental structures is a difficult process which requires high precision. In digitizers available in the state of the art, precision is greatly impaired by the complexity of the device's functioning or because of human imprecision. It is therefore one object of the present invention to provide a digitizing device for dental structures that is precise and efficient, generating unequivocal three-dimensional data.

A moulding procedure involves time and detailed work. The copy of a prosthetic preparation, for example, requires confection of an individual mould and subsequent adjustments. This molding technique, used by most dentistry professionals, takes long appointment time, weariness of the patient and plaster models which are frequently inexact in detail and with many distortions that oblige the dentist to repeat the procedure. A printing should reproduce the prepared teeth, neighboring teeth and adjacent tissue, with the exact dimension of the registered zones. It is therefore, another object of the present invention to provide a clinical odontological method, here referred to as “clinical protocol”, for producing dental structure moulds, said method using a device that does not cause discomfort to the patient and which generates very accurate three-dimensional data, so that the dental structure be used to make a mould in three dimensions. This fact represents a significant evolution in the clinical molding procedure in fixed prosthesis.

### DETAILED DESCRIPTION OF THE INVENTION

As already mentioned above, the present invention aims to describe a digitizing device for dental structures with direct mouth scanning. The invention has as one objective to enable dental surgeons to make copies of their patients' teeth data by passing the digitizer with an articulated arm at selected points and sending information to software, transforming them in data for 3D. The data thus supplied may be transformed in pieces for later confection of the ceramic crown. This fact will allow the dental surgeon to use an original technology and which will certainly reach international projection of utilization and commercialization.

The prototype of the digitizer of dental structures here described was built as an improvement over a contact scanner known as MicroScribe-G2X, described in the North American U.S. Pat. No. 6,134,506, here incorporated as reference, which is currently used in the shoe industry. Structural modifications were made from this equipment, with the introduction of probes (pointers) and new image scanning to adapt and use directly on patients' dental structure. With these modifications, a precise scan of the dental surface is obtained, with greater precision of data obtained from dental structures in regions of difficult access, such as molar sub-gingival areas. This method is made possible considering two main characteristics of the digitizer: pointer accuracy and articulated arm. Accuracy means the detail obtained at the limits of a surface (which in fixed prosthesis is a condition of success of the prosthetic work), important, principally in limit areas and lines, which can only be conquered with this mechanism of points and contact. Until now, it is believed that there is no other way of mouth scanning with precision and detail that does not use the questioned surface tracking touching and marking reference points or clouds.

The digitizer here proposed comprises an articulated arm which provides a spatial position of the equipment in relation to the points that should be traced, and through calculations and deviations, adjusts the spatial position to the actual scan. The articulated arm accomplishes the scanning possibility directly in the mouth, because the dentist's reference is a moving point, that is, the patient. In this way, after the dental structure which will receive a metal-free prosthetic crown is prepared, the clinical odontological protocol starts, that is: the patient is positioned at a specific head inclination, the computer is turned on, the software is run, the digitizer is located on the fixed base, and afterwards, the articulated arm should be positioned in a correct manner, to permit access to the exact scan place. Supported by the hand, as if it were a pencil, the pointer starts tracking the surface and consecutively with a pedal these punctual areas will be frozen. Freezing many superficial points (the more points, the greater the precision of the 3D object) generates to software a series of lines which, little by little, will be united, creating a geometric figure with real shape and detail.

Detailed contact scanning is done through the adapted pointers according to presented access necessities. The referred pointers should be supplied by the manufacturer of the dental structure digitizer in the following manner: standard probe component upon buying the mouth scanner kit (scanner, software, manual, standard pointer)—additional probes would be sold separately according to each dentist's scanning necessities. Other probe models would have different angle configurations, according to the regions of access in the mouth cavity. The probe kits with 45° and 110° angle configurations would be specific for hindmost areas, such as superior and inferior molars, facilitating the scanner's position on the indicated place without access restrictions. Adaptation of these pointers is justified not only by access facility, but also for allowing a more detailed and fine scan of the end of the preparation, a requirement necessary for the confection metal-free prosthetic crowns. A base connected to a computer is part of the dental structure digitizer kit.

The method of the invention is innovative over the methodologies currently applied to moulds and molding materials, which would be substituted by the use of the dental structure digitizer. Therefore, with the device of the invention one can consider having a clinical protocol which involves preparation of the dental remainder and immediately scanning its surface through a sequence determined by points and contact. Once this sequence is concluded, a grid of values is generated which is instantaneously stored and translated in the computer by a specific software, which will be supplied with the dental structure digitizer kit. The software enables transformation of these points into a three-dimensional structure true to the original tooth's anatomic details. Once possessing these real and precise information, the dental surgeon sends to the prostheses laboratory for confection of a prosthetic structure the remaining tooth with a much better adaptation. Thus, several advantages can be attained with the device of the invention, including but not limiting to: work time reduction during procedure of the fixed prosthesis confection; minimization of the fixed prosthesis confection steps; maximization in the adaptation of ceramic pieces; minimization of errors in moulding procedures; enablement of use of the digitizers in dental offices, creating a kit (digitizer, manual, software, standard probe); advancing the use of technological resources in odontology; evidencing the importance of the application of CAD/CAM resources in odontology.

The skilled person will readily appreciate the teachings of the present invention. Subtle variations in the device and/or herein described should be deemed as within the scope of the invention and of the appended claims.

1. Apparatus for digitizing dental structures comprising at least one articulated arm and at least one probe, said at least one articulated arm and said at least one probe providing dental structure scanning directly by mouth contact.

2. Apparatus, according to claim 1, wherein said at least one articulated arm and/or said at least one probe articulates in several angles.

3. Apparatus, according to claim 1, wherein said at least one articulated arm supplies a spatial position of the digitizing equipment in relation to the dental points to be traced, so as to adjust the spatial position of an actual digitizing scan.

4. Apparatus, according to claim 1, further comprising an adaptation in the probe pointer, so as to favor the access to a tooth and to enable finer and more detailed scanning of a finished preparation.

5. Apparatus, according to claim 1, further comprising means for obtaining, storing and/or processing the digital data obtained from the dental structure scanning.

6. Method for three-dimensional data scanning of a dental structure comprising at least one step of dental structure scanning directly by mouth contact, by means of an apparatus for digitizing dental structures comprising at least one articulated arm and at least one probe.

7. Method, according to claim 6, wherein the user digitizes the dental structures by tracing manual points with pointers adapted to said at least one articulated arm.

8. Method, according to claim 6, wherein the digitized information from the scanning is further processed by a software capable of composing a 3D image of the dental structure's actual surface which will thereafter receive a prosthetic crown.

9. Method, according to claim 6, wherein the at least one probe and/or the at least one articulated arm provide articulation in several angles, thus providing superior accuracy characteristics.

10. Method, according to claim 6, wherein the at least one probe and the at least one articulated arm provide greater precision of data obtained from the dental structures in regions of difficult access.

11. Apparatus, according to claim 2, wherein said angles are 45°, 90° and 110°.

12. Method, according to claim 9, wherein said angles are 45°, 90° and 110°.

13. Method, according to claim 10, wherein the region of difficult access is a molar sub gingival area.
